(19) United States
(12) Patent Application Publication
(10) Pub. No.: US 2020/0410832 A1
(43) Pub. Date: Dec. 31, 2020

(54) Methods of Cautioning and Alerting within Umbras, and Penumbras of Physical Access Control Systems

(71) Applicant: BRIVO SYSTEMS, LLC., Bethesda, MD (US)

(72) Inventors: JOHN Szczygiel, Bethesda, MD (US); Steven Van Till, Bethesda, MD (US); Steven Mark Bryant, Bethesda, MD (US)

(21) Appl. No.: 17/013,656

(22) Filed: Sep. 7, 2020

Related U.S. Application Data
(63) Continuation-in-part of application No. 16/042,290, filed on Jul. 23, 2018.
Application No. 16/042,290 is a continuation-in-part of application No. 15/936,083, filed on Mar. 26, 2018.

(51) Int. Cl. G08B 13/196; G07C 9/29; G07C 9/00; H04W 4/021; G08B 25/10; G06T 11/60

(52) U.S. Cl. CPC G08B 13/19691; G07C 9/29; G06T 11/60; H04W 4/021; G08B 25/10; G07C 9/00309

(57) ABSTRACT

A method of operation triggers an alert when cameras or sensors determine an action e.g. entry into or occupancy of a reserved region. The system transmits a caution to the pilgrim to present a credential or affirm proper attire and safety equipage upon entry into the penumbra of the reserved region. Within the penumbra, a pilgrim may preempt the access control challenge or alert by presenting his credential or by signally his intention to enter the reserved region. A process of the surveillance and security system includes recording all entries and occupancy of reserved areas but suppressing alarms and alerts on the condition that a credential bearer is within the geo-fenced region. A reserved area has both umbra and penumbra regions with various effects of entry, occupancy, and presentation of credentials. Receiving a presented credential causes alerts to be preempted in the penumbra and to be unfaulted in the umbra.

### CROSS-REFERENCE TO RELATED APPLICATIONS

The present application is a continuation-in-part application of Ser. No. 16/042,290 filed Jul. 23, 2018 which is incorporated by reference and which is a continuation in part of pending Ser. No. 15/936,083 which is incorporated by reference in its entirety. The present invention is also a continuation in part of 16/011,188 filed Jun. 28, 2018 and benefits from its priority date.

### STATEMENT REGARDING FEDERALLY SPONSORED RESEARCH OR DEVELOPMENT

Not Applicable.

### THE NAMES OF THE PARTIES TO A JOINT RESEARCH AGREEMENT

Not Applicable.

### INCORPORATION-BY-REFERENCE OF MATERIAL SUBMITTED ON A COMPACT DISK OR AS A TEXT FILE VIA THE OFFICE ELECTRONIC FILING SYSTEM (EFS-WEB)

Not Applicable.

### STATEMENT REGARDING PRIOR DISCLOSURES BY THE INVENTOR OR A JOINT INVENTOR

Not Applicable.

### BACKGROUND OF THE INVENTION

### Technical Field

The disclosure relates physical access control systems, doors, locks, and wireless credentials.

### Background

As is known, installing a door with electronic door strike apparatus, wired to an access control panel is very expensive. Also, an area which needs protection may not have a door. A harbor, depot, or port for example must be open at all hours.

A camera or other sensor system can record entry or passage and generate alerts. There are many situations where actual physical locking of a region is not practical or required yet where notification after unauthorized access is necessary. But simply creating an alert every time someone enters the area can overwhelm the receiver with too many alarm alerts, causing them to ignore the alarms.

What is needed is a system to track, control, and protect an area or region where physical enclosure or locking is impractical or uneconomic. Responding to entry into a large or insensitive area may not be immediately urgent and an appropriate alert may trigger a gradual remediation or casual investigation. An example may be an office or recreation area after hours. A system is needed that allows for legitimate entry into an area to be ignored when proper credentials are presented to enter said area. And users with some type of credential may be presumed to either have innocuous or legitimate reasons for transiting an area not normally in their sphere of activity.

### BRIEF SUMMARY OF INVENTION

A method of operation of a physical access control system (PACS) triggers an alert when cameras or sensors determine an action e.g. entry into or occupancy of a reserved region. The system transmits a caution to the pilgrim to present a credential or affirm proper attire and safety equipage upon entry into the penumbra of the reserved region. Within the penumbra, a pilgrim may preempt the access control challenge or alert by presenting his credential or by signally his intention to enter the reserved region. A process of the surveillance and security system includes recording all entries and occupancy of reserved areas but suppressing alarms and alerts on the condition that a credential bearer is within the geo-fenced region. A reserved area has both umbra and penumbra regions with various effects of entry, occupancy, and presentation of credentials. Receiving a presented credential causes alerts to be preempted in the penumbra and to be unfaulted in the umbra.

The invention is a system that virtualizes rooms and doors for a physical access control system by defining for the purpose within this patent application of umbras and penumbras as reserved physical regions, areas, and volumes based on geo-fencing or signal strength of electromagnetic transmitters and receivers. The analogy is to the umbras and penumbras of constitutional law and certainly not to shadows and partial shadows of astronomical objects or light pixels. A physical access control system embodiment of the invention triggers an alert when cameras or sensors determine an action e.g. entry into or occupancy of a reserved region.

The bearer of a credential may suppress triggering an alert prior to entry into the periphery of the reserved region.

The bearer of a credential may suppress triggering an alert post entry into the reserved region, unfaulting the alert.

The system may caution the pilgrim to present a credential or affirm proper attire and safety equipage upon entry into the penumbra of the reserved region.

Within the penumbra, a pilgrim may preempt the access control challenge or alert by presenting his credential or by signally his intention to enter the reserved region.

A user may initiate a request or responsively present his credential to enter an area. Upon receiving approval, video monitoring systems trigger an event recordation but a security system suppresses an alarm or alert. Based on a policy the approval may allow one-time or for a period of time or for a fixed number of entries within a time period.

A server is communicatively coupled to at least one gatekeeper apparatus, at least one portal actuator, and to at least one mobile visitor device. Responsive to the gatekeeper apparatus which may be a mobile device, the server synthesizes and revokes pairs of anti-tokens and tokens upon demand or by appointment. Anti-tokens are distributed to portals and tokens are transmitted to mobile visitor devices. When a portal matches an anti-token distributed from the server with a token presented by a mobile visitor, it actuates. Unmatchable tokens are stored at the portal and forwarded to the server which may reply with the matching anti-token or trigger an alert. Requests for access are received from the visitor device by the server and forwarded to the designated gatekeeper which may respond with a synthesis command or a denial. Tokens and anti-tokens include location and data-time validity indicia which must also match that of the portal. Tokens and anti-tokens selectably expire after a number of uses or persist through a date-time range which may be semi-infinite, scheduled by time of day, or day of week, etc. Gatekeeper apparatus, mobile visitor devices, and even portals may be location aware and their operation may depend on operating within boundaries within a campus, port, or electronic enclosure. Ports include harbors, airports, and transportation secured areas such as bridges and tunnels. Powered transport or mobility devices may be operable within regions of a shopping mall or factory or larger entity such as an aircraft carrier. Depending on policies, the gatekeeper may be remote or local to the protected property. A resident of a gated or enclosed community may be anywhere in her apartment, house, on the campus, or remote. She may have visitors of various trust relationships ranging from family, service providers, delivery couriers, social guests, and health/home aides. A wireless system enables her to provide unscheduled or roaming access through a multi-level lock system without being bound to conventional wall-mounted intercom units. The hostess may admit early, prompt, or late guests to a social/meeting room from her apartment, hallways, or the venue of the event after it has begun. She does not need to wait in the lobby to escort the visitor. The route of the visitor is limited to attend the gathering (and toilets). Route guidance may be provided from entry to destination, to emergency exits, and to nearest. Service providers may be admitted to infrastructure areas of the building or campus for plumbing, instruction, training, storage, or cleaning. A geolocation system may ensure that the gatekeeper is somewhere within certain buildings or campus and that the visitor is in the vicinity of each multi-level lock or portal. The system enables scheduled access for deliveries. This can be accomplished via integration with a delivery service dispatch controller thus enabling a delivery agent access through perimeter portals to the property. A refrigerated space may be unlocked for perishable goods. License plate or QR code recognition causes remote means to trigger a door or trunk release. Audio and visual transmission of the visitor and his identification enables a verification of both credential and proximity and record keeping of deliveries and visitors.

### BRIEF DESCRIPTION OF DRAWINGS

The foregoing and other objects, aspects, features, and advantages of the disclosure will become more apparent and better understood by referring to the following description taken in conjunction with the accompanying drawings, in which:

FIG. 1 is a block diagram of a system.

FIGS. 2-4 are flowcharts of method embodiments;

FIGS. 5A, 5B, and 5C illustrate a penumbra (P) and umbra (U) of a region of restricted access; and

FIG. 6 is a block diagram of a processor suitable for performing a method embodiment of the invention.

### DETAILED DESCRIPTION OF INVENTION

The present invention extends mobile wireless physical access controls to regions of reserved access which have no physical access control (e.g. doors) or impenetrable enclosure.

### Embodiments of the Invention: Area Protection Example

Using a video camera that generates alerts, couple this with a cloud based access control system such as a Brivo Access Control Cloud and an electronic application on a mobile device, such as a Brivo Mobile Pass App where:

1. Using Brivo Mobile Pass App, the user submits his credential to the Cloud Server to enter Area U

2. The Cloud Server sends response to Mobile Pass App granting permission.

3. User then enters area U.

4. Video camera monitoring Area U trigger event to Brivo Cloud Server.

5. Brivo cloud server suppresses alert since credential was presented within a stored period, TBD, seconds of event.

Another exemplary embodiment is a Virtual Door example:

Using a Door open/closed switch (monitored by Brivo Cloud Server), Brivo Cloud Server and Brivo Mobile Pass App where:

1. Using Brivo Mobile Pass App, the user submits his credential to the Cloud Server to enter Door (D)

2. The Cloud Server sends response to Mobile Pass App granting permission.

3. User then opens Door.

4. Door switch monitored by Brivo Cloud Server is triggered.

5. Brivo cloud server suppresses alert since credential was presented within a stored period, TBD, seconds of door switch event.

The suppression can have a variable length of time. A first credential can be good for the next 8 hours, suppressing any area alerts for the entire day.

Variation: Using location services such as but not limited to GPS awareness of “allowed” user within area, suppress alarm (completely frictionless).

In other words, the system makes a friend vs foe decision based on the presence of a mobile credential that has the right authorization. So, for example, if a user wanders into a space (or open a door) where he or she is allowed (and has his phone), then no alarm. When someone without credentials does the same, the event triggers alerts and alarms.

A surveillance camera may annotate a virtual credential to an image of person by facial recognition who has previously authenticated using the mobile credential.

In an embodiment, the mobile credential application forwards a continuous location service such as but not limited to GPS. When the physical access control system receives a motion alarm, server suppresses an alarm on the condition that an allowed person (via location services coordinates) is within the area or performs a requested action. When the user's mobile app detects the user on track (P) to enter the protected area (U), the mobile app automatically sends the credential to the server.

In an embodiment, location service awareness of the mobile app can “prompt” the user (by triggering an audio or a haptic actuator), to submit their credential to enter the protected area.

Separately location service can also be used to verify that the user is in fact near to the protected area (penumbra P), submission of credential can be denied if the user is not within P, the vicinity of the protected area.

But simply creating an alert every time someone enters the area can overwhelm the receiver with too many alarm alerts, causing them to ignore the alarms.

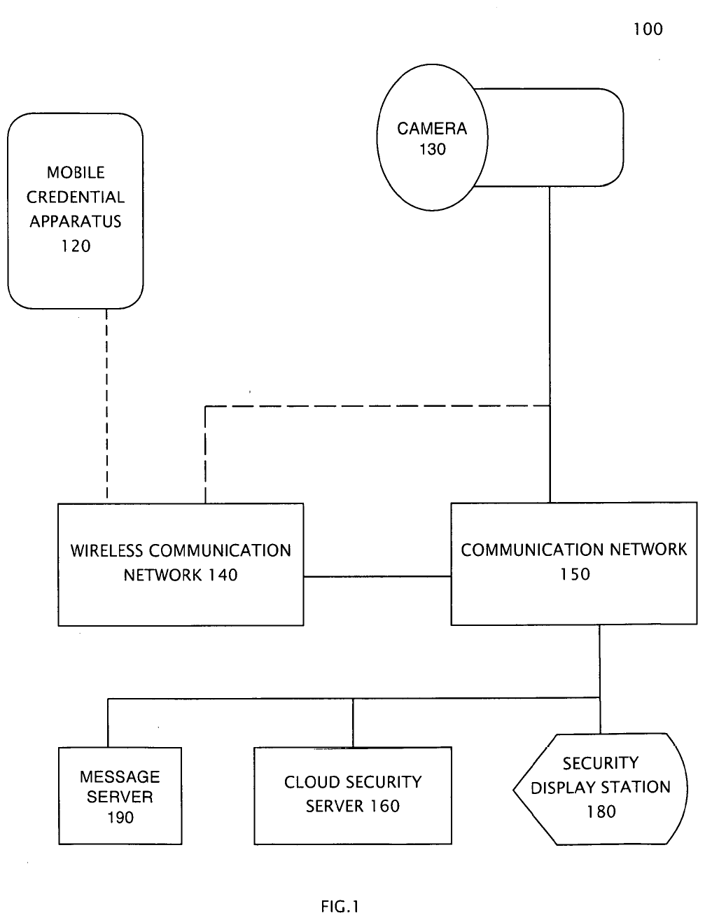

As shown in FIG. 1 the system 100 includes at least one mobile credential apparatus having a location sensor 120, a camera 130; a wireless communication network 140, a wired communication network 150; a cloud security server 160, a security display station 180, and a message server 190.

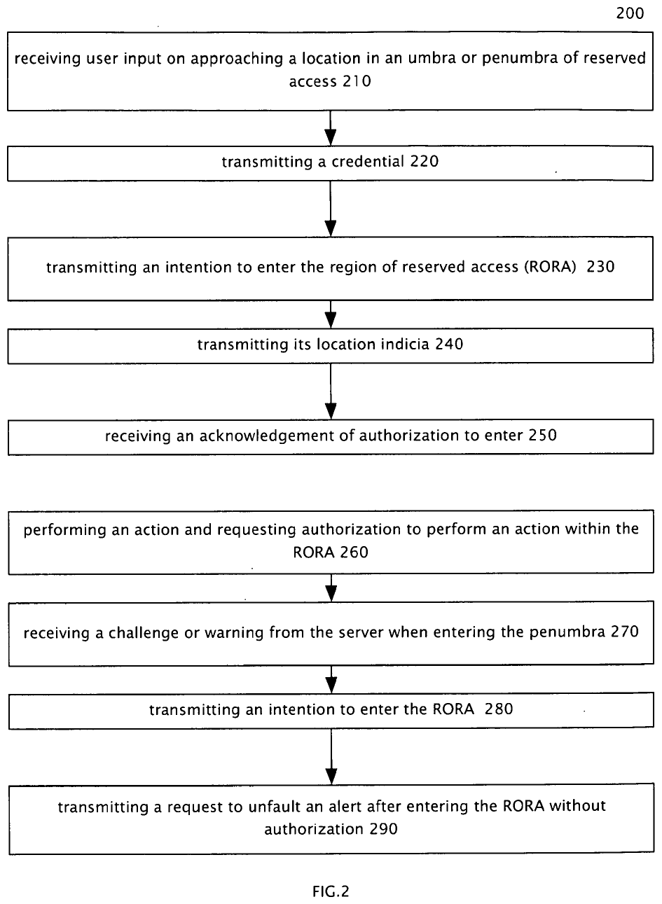

A method 200 shown in FIG. 2 at a mobile credential device includes, receiving user input on approaching a location in an umbra or penumbra of reserved access 210, transmitting a credential 220, transmitting an intention to enter the region of reserved access (RORA) 230, transmitting its location indicia 240, and receiving an acknowledgement of authorization to enter 250. In an embodiment, the method also includes performing an action and requesting authorization to perform an action within the RORA 260. In an embodiment, the method also includes receiving a challenge or warning from the server when entering the penumbra 270. In an embodiment, the method also includes transmitting an intention to enter the RORA 280. In an embodiment, the method also includes transmitting a request to unfault an alert after entering the RORA without authorization 290.

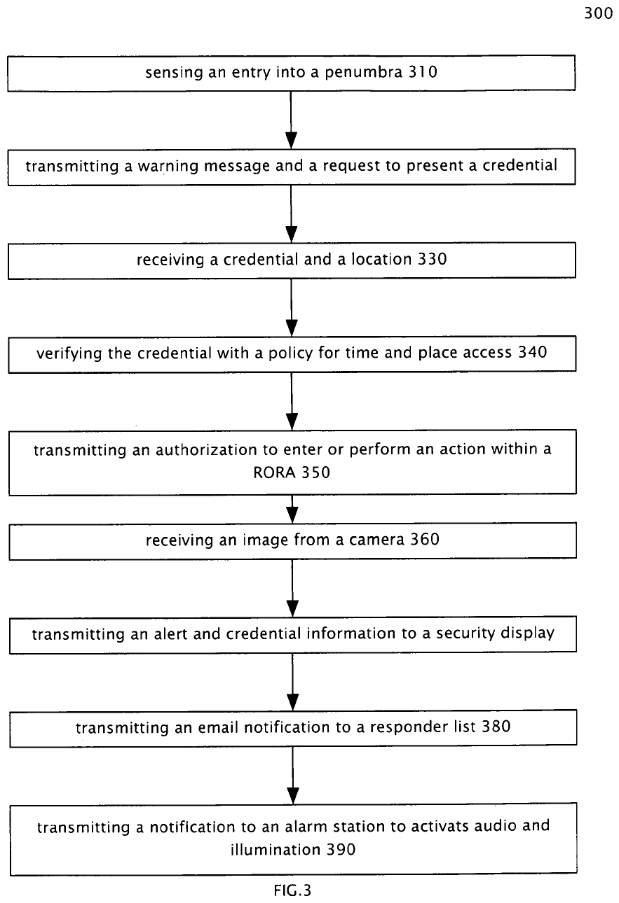

A method 300 at a server, shown in FIG. 3, includes receiving a credential and a location 330, verifying the credential with a policy for time and place access 340, transmitting 350 an authorization to enter or perform an action within a RORA. In an embodiment, receiving an image from a camera 360 and transmitting an alert 370 and credential information to a security display station when no authorization has been transmitted within a range of time. In an embodiment, unfaulting the alert upon receiving a credential and request to unfaulty the alert after entering the RORA. In an embodiment, sensing an entry into a penumbra 310, and transmitting 320 a warning message and a request to present a credential. In an embodiment, transmitting an email notification or text message to a responder list 380. In an embodiment, transmitting a notification to an alarm station 390 to activating a local alarm audio and illumination, or a person to contact a police station for response.

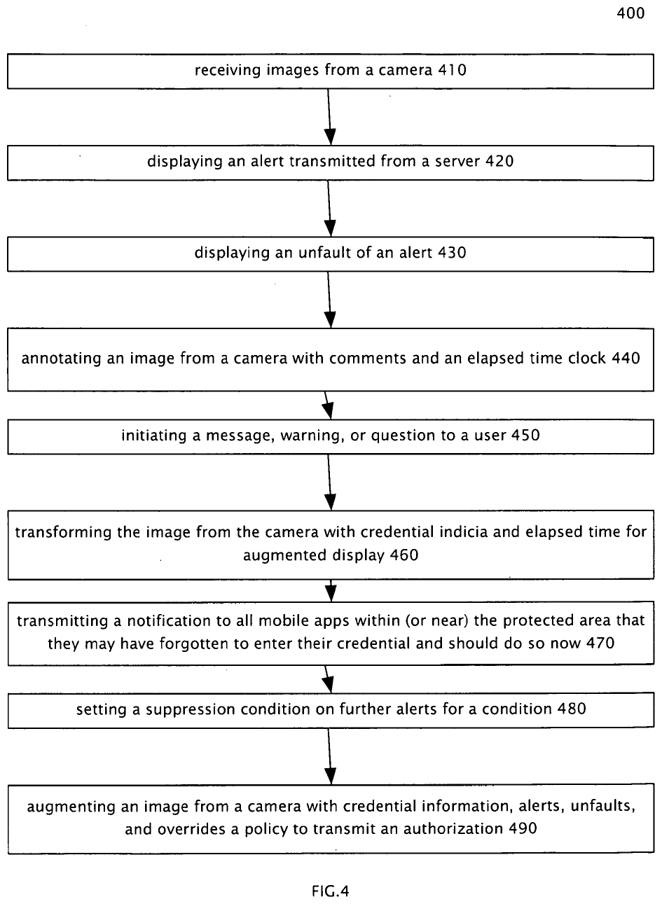

A method 400 at a security server, shown in FIG. 4, includes receiving images from a camera 410, transmitting an alert 420, transmitting an unfault of an alert 430, annotating 440 an image from a camera with comments and an elapsed time clock, initiating a message, warning, or question to a user 450, and transforming the image from the camera with credential indicia and elapsed time for augmented display 460.

Other embodiments include: transmitting a notification to all mobile apps within (or near) the protected area that they may have forgotten to enter their credential and should do so now 470 also that there may be an actual intruder in the area. In an embodiment, the security display station sets a suppression condition on further alerts for a condition 480. In an embodiment, the security display station augments an image from a camera with credential information, alerts, unfaults, and overrides a policy to transmit an authorization 490.

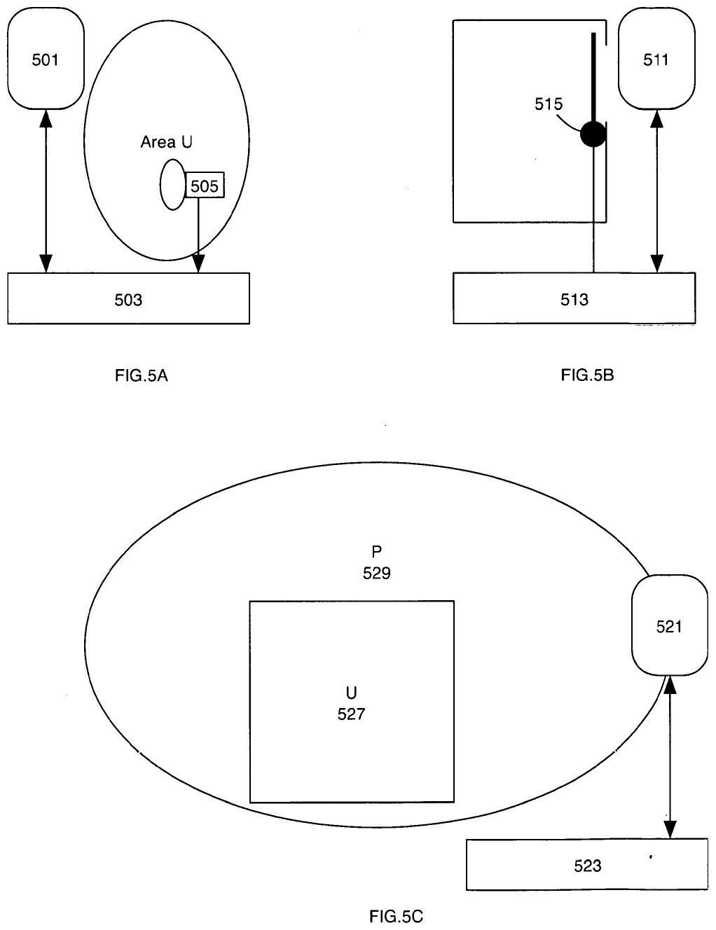

FIG. 5A illustrates a first example of operation. A mobile device 501 presents its credential to a server 503 and receives permission to enter Area U. Upon entry, camera 505 records images of the visitor and reports it to the server 503 but no alert is issued because the mobile device has performed the earlier transaction. FIG. 5B illustrates an example of a instrumented door 515 which when opened reports to a server 513. Again, when the mobile device 511 has previously presented a credential and received permission to enter, the operation of the door does not cause an alert. In embodiments there may be a grace period for short incursion or for a slightly delay or latency in performing the credential presentation and permission. FIG. 5C illustrates a location services based example where there is a Penumbra (P) 529 region surrounding the Umbra (U) 527 region. When the mobile device 521 is outside the Penumbra, no credential is accepted or required. The server 523 may challenge or prompt the user to request access to the Umbra when the device passes into the Penumbra. An alert is triggered when the mobile device passes into the Umbra (U) 527 region.

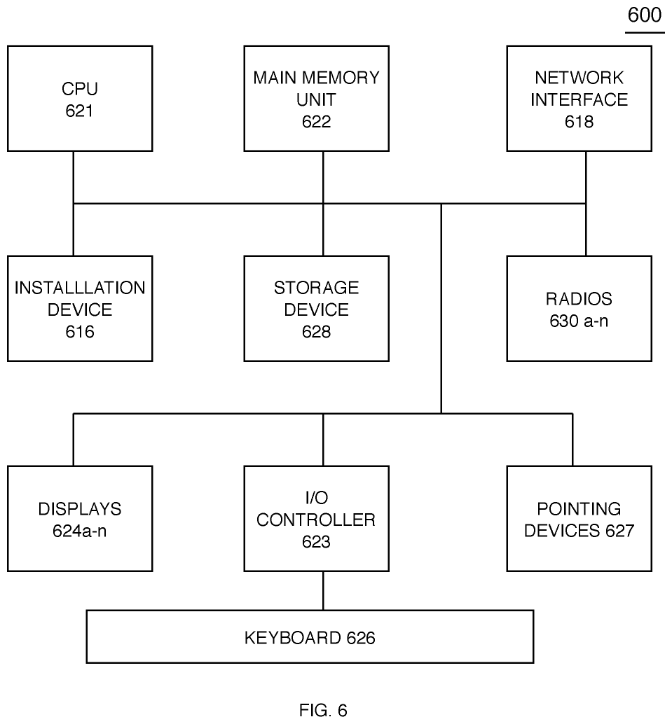

FIG. 6 is a block diagram of an exemplary processor 600 configured by computer executable instructions encoded in non-transitory media to perform the steps, transformations, and decision processes of a method embodiment of the invention.

Aspects of the invention can be appreciated as methods, apparatuses, and systems combining such methods and apparatuses.

For the purpose of this application, applicant defines the terms umbra and penumbra. While in the penumbra, the user may submit a credential to enter the umbra. Messages and challenges may be presented to the user when occupying the penumbra. A security credential apparatus may be triggered to transmit the credential when entering the penumbra. After passage through the penumbra, an alert will be triggered upon entry into the umbra unless a credential has been submitted. The user may request an unfault of the alert by presenting the credential after entry into the umbra. A system may be configured to suspend an alarm or issue a second warning during a span of time when a party has not submitted a credential. A policy may allow a short incursion into an umbra without triggering an alert or an alarm.

Aspects of the invention are methods, apparatus, and system. One aspect of the invention is a system including: at least one mobile credential device having a location sensor; a camera; a server coupled to said camera and to said mobile credential device; a message server; a security display station, and a communication network coupling all the above.

Another aspect of the invention is a method at a mobile credential device including: receiving a user input of intention to enter an area of reserved access; transmitting a credential; transmitting an intention to enter the region of reserved access (RORA); transmitting its location indicia; and, receiving at least one of an acknowledgement and a rejection of authorization to enter.

In an embodiment the method also includes performing an action and requesting authorization to perform an action within the RORA.

Another aspect of the invention is a method at a mobile credential device including: receiving a challenge or warning from the server when entering the penumbra; transmitting a credential; transmitting an intention to enter the region of reserved access (RORA); transmitting its location indicia; and, receiving at least one of an acknowledgement and a rejection of authorization to enter.

Another aspect of the invention is, at a server, issuing an alert only when incursion is greater than a threshold.

In an embodiment the method also includes transmitting a request to unfault an alert after entering the RORA without authorization.

In an embodiment the method also includes requiring a user to perform an action; and transmitting success to the server.

Another aspect of the invention is, at a server, receiving a credential and a location; verifying the credential with a policy for time and place access; and, transmitting an authorization to enter or perform an action within a RORA.

Another aspect of the invention is a method at a server, including: receiving an image from a camera; initiating a message, warning, or question to a user; and transmitting an alert and credential information to a security output means (email, display, SMS) when no authorization has been transmitted within a range of time.

In an embodiment, the method includes unfaulting the alert upon receiving a credential and request to unfault the alert after entering the RORA.

Another aspect of the invention is a method at a server including sensing an entry into a penumbra; and, transmitting a warning message and a request to present a credential.

Another aspect of the invention includes at a server transforming an image from a camera with credential indicia for transmission to a security display station.

Another aspect of the invention is a method at a security display station, including: receiving images from a camera; displaying an alert transmitted from a server; displaying an unfault of an alert; annotating an image from a camera with comments and an elapsed time clock; and, transforming the image from the camera with credential indicia and elapsed time for augmented display.

In an embodiment, the method includes setting a suppression condition on further alerts for a condition.

In an embodiment, the method includes augmenting an image from a camera with credential information, alerts, unfaults, and overriding a policy to transmit an authorization.

In an embodiment, the method also includes refusing submission of credential when the user is not within the vicinity of the protected area.

Another aspect of this invention is a method at a cloud security server, including notifying at least one mobile device of intrusion on the condition that an unauthorized presence is in its vicinity based on location service coordinates. Another aspect of the invention is a skeletonization circuit coupled to said camera and a method of counting people present in view and alerting when the count exceeds the number of credentials.

Another aspect of this invention is a method at a mobile credential device, including notifying the user that to submit a credential, on the condition that at least two location measurements converge toward region of restricted access. Another aspect of this invention is a method at a mobile credential device, including transmitting a credential on the condition that at least two location measurements converge toward a region of restricted access.

Another aspect of the invention is a system which includes at least one electronically controlled portal actuator coupled to an access control server and a plurality of mobile communication devices. In an embodiment, the server relays an access request to the mobile communication device of the party authorizing access. The access request may include video and audio or text and credential e.g. scanned badge or chip. A server is wirelessly coupled to mobile communication devices of gatekeepers e.g. tenants and residents of a community and to mobile communication devices of visitors. Each device provides geolocation indicia to the server for secure access control. A gatekeeper views the visitor, his badges, and the surroundings before enabling access through a portal to one or more of the areas. The visitor calls an alias phone number to request access, the server redirects the audio-visual connection to the mobile identity number of the resident which is not revealed to the visitor. When the resident is herself within the building or the campus she enables access through a single portal or through a route specific to the role of the visitor. The server actuates at least one portal and enables the visitor through a sequence of portal e.g. elevators/stairways to the allowed destination. The request, authorization, and transit records are stored. An alert is triggered when the visitor fails to arrive at a destination or exit the premises within an allowable window of time.

Another aspect of the invention is a method of processes for a Visitor mobile communication device performing the following processes: receiving indicia that the visitor mobile communication device is in proximity to a portal; transmitting an on demand request for access; transmitting assurance indicia such as image, voice, credentials, RFID, and location to a server; receiving and storing a token; transmitting a token; receiving an invitation from a server to access through a portal actuator device; and requesting a token to access a location specific portal within a date-time range. Another aspect of the invention is processes for a gatekeeper device performing the processes: scheduling access through location specific portal control actuators for visitors; responding to requests for on-demand access through location specific actuators; evaluating texts, images, and audio for assurance that requestors are authentic; instructing the server to synthesize/revoke pairs of anti-tokens and tokens for transmittal and distribution; and enabling operation of the gatekeeper device when it is within boundaries. Another aspect of the invention is processes for an access control server performing the following processes: receiving from a gatekeeper device a request for access through at least one portal actuator control device at a location and a data-time range; synthesizing a token and an anti-token for a specific location and date-time range; transmitting said token to a visitor authentication device; distributing said anti-token to at least one portal actuator control device; receiving an on-demand request for access through at least portal actuator control device; determining from location, text, images, and biometrics authenticity of the on-demand request and relaying said request to an appropriate gatekeeper; transmitting a portal actuation command when a token matches an anti-token, and alerting when a portal actuator control device reports transit activity of a visitor authentication device off route, lingering, or out of validity. Another aspect of the invention is processes for a portal actuator control device having the processes: receiving from a server and storing an anti-token valid for a date-time range and location; receiving from a visitor mobile device and storing a token valid for a date-time range and location; actuating a portal control device when said token and anti-token both match a date-time range and location; transmitting an alert when receiving an unmatched token or an invalid token; and discarding expired tokens and anti-tokens.

### CONCLUSION

A system is needed that allows for legitimate entry into an area to be ignored when proper credentials are presented to enter said area. The key distinguishing feature is presenting a valid credential prior to entry into the monitored area. Thus it can be appreciated that the invention is easily distinguished from conventional visitor entry systems by, elimination of a display directory of resident names, phone numbers, or unit numbers at a door improving their privacy; generation of location specific tokens for access at specific or persistent schedules; alerting when a visitor lingers at or transits a portal not en route to the intended destination; multiple levels of assurance for visitors; support for transporters assigned to ferry visitor/guests; and a failover system for visitors who have lost mobile connectivity.

As is known, circuits disclosed above may be embodied by programmable logic, field programmable gate arrays, mask programmable gate arrays, standard cells, and computing devices limited by methods stored as instructions in non-transitory media. Generally a computing devices 600 can be any workstation, desktop computer, laptop or notebook computer, server, portable computer, mobile telephone or other portable telecommunication device, media playing device, a gaming system, mobile computing device, or any other type and/or form of computing, telecommunications or media device that is capable of communicating on any type and form of network and that has sufficient processor power and memory capacity to perform the operations described herein. A computing device may execute, operate or otherwise provide an application, which can be any type and/or form of software, program, or executable instructions, including, without limitation, any type and/or form of web browser, web-based client, client-server application, an ActiveX control, or a Java applet, or any other type and/or form of executable instructions capable of executing on a computing device.

FIG. 6 depicts block diagrams of a computing device 600 useful for practicing an embodiment of the invention. As shown in FIG. 6, each computing device 600 includes a central processing unit 621, and a main memory unit 622. A computing device 600 may include a storage device 628, an installation device 616, a network interface 618, an I/O controller 623, display devices 624a-n, a keyboard 626, a pointing device 627, such as a mouse or touchscreen, and one or more other I/O devices 630a-n such as baseband processors, Bluetooth, Global Positioning System (GPS), and Wi-Fi radios. The storage device 628 may include, without limitation, an operating system and software.

The central processing unit 621 is any logic circuitry that responds to and processes instructions fetched from the main memory unit 622. In many embodiments, the central processing unit 621 is provided by a microprocessor unit, such as: those manufactured under license from ARM; those manufactured under license from Qualcomm; those manufactured by Intel Corporation of Santa Clara, Calif.; those manufactured by International Business Machines of Armonk, N.Y.; or those manufactured by Advanced Micro Devices of Sunnyvale, Calif. The computing device 600 may be based on any of these processors, or any other processor capable of operating as described herein.

Main memory unit 622 may be one or more memory chips capable of storing data and allowing any storage location to be directly accessed by the microprocessor 621. The main memory 622 may be based on any available memory chips capable of operating as described herein.

Furthermore, the computing device 600 may include a network interface 618 to interface to a network through a variety of connections including, but not limited to, standard telephone lines, LAN or WAN links (e.g., 802.11, T1, T3, 56 kb, X.25, SNA, DECNET), broadband connections (e.g., ISDN, Frame Relay, ATM, Gigabit Ethernet, Ethernet-over-SONET), wireless connections, or some combination of any or all of the above. Connections can be established using a variety of communication protocols (e.g., TCP/IP, IPX, SPX, NetBIOS, Ethernet, ARCNET, SONET, SDH, Fiber Distributed Data Interface (FDDI), RS232, IEEE 802.11, IEEE 802.11a, IEEE 802.11b, IEEE 802.11 g, IEEE 802.11n, CDMA, GSM, WiMax and direct asynchronous connections). In one embodiment, the computing device 600 communicates with other computing devices 600 via any type and/or form of gateway or tunneling protocol such as Secure Socket Layer (SSL) or Transport Layer Security (TLS). The network interface 118 may comprise a built-in network adapter, network interface card, PCMCIA network card, card bus network adapter, wireless network adapter, USB network adapter, modem or any other device suitable for interfacing the computing device 600 to any type of network capable of communication and performing the operations described herein.

A computing device 600 of the sort depicted in FIG. 6 typically operates under the control of operating systems, which control scheduling of tasks and access to system resources. The computing device 600 can be running any operating system such as any of the versions of the MICROSOFT WINDOWS operating systems, the different releases of the Unix and Linux operating systems, any version of the MAC OS for Macintosh computers, any embedded operating system, any real-time operating system, any open source operating system, any proprietary operating system, any operating systems for mobile computing devices, or any other operating system capable of running on the computing device and performing the operations described herein. Typical operating systems include, but are not limited to: WINDOWS 10, manufactured by Microsoft Corporation of Redmond, Wash.; MAC OS and iOS, manufactured by Apple Inc., of Cupertino, Calif.; or any type and/or form of a Unix operating system.

In some embodiments, the computing device 600 may have different processors, operating systems, and input devices consistent with the device. In other embodiments, the computing device 600 is a mobile device, such as a JAVA-enabled cellular telephone or personal digital assistant (PDA). The computing device 600 may be a mobile device such as those manufactured, by way of example and without limitation, Kyocera of Kyoto, Japan; Samsung Electronics Co., Ltd., of Seoul, Korea; or Alphabet of Mountain View Calif. In yet other embodiments, the computing device 600 is a smart phone, Pocket PC Phone, or other portable mobile device supporting Microsoft Windows Mobile Software.

In some embodiments, the computing device 600 comprises a combination of devices, such as a mobile phone combined with a digital audio player or portable media player. In another of these embodiments, the computing device 600 is device in the iPhone smartphone line of devices, manufactured by Apple Inc., of Cupertino, Calif. In still another of these embodiments, the computing device 600 is a device executing the Android open source mobile phone platform distributed by the Open Handset Alliance; for example, the device 600 may be a device such as those provided by Samsung Electronics of Seoul, Korea, or HTC Headquarters of Taiwan, R.O.C. In other embodiments, the computing device 600 is a tablet device such as, for example and without limitation, the iPad line of devices, manufactured by Apple Inc.; the Galaxy line of devices, manufactured by Samsung; and the Kindle manufactured by Amazon, Inc. of Seattle, Wash.

As is known, circuits include gate arrays, programmable logic, and processors executing instructions stored in non-transitory media provide means for scheduling, cancelling, transmitting, editing, entering text and data, displaying and receiving selections among displayed indicia, and transforming stored files into displayable images and receiving from keyboards, touchpads, touchscreens, pointing devices, and keyboards, indications of acceptance, rejection, or selection.

It should be understood that the systems described above may provide multiple ones of any or each of those components and these components may be provided on either a standalone machine or, in some embodiments, on multiple machines in a distributed system. The phrases in one embodiment’, in another embodiment’, and the like, generally mean the particular feature, structure, step, or characteristic following the phrase is included in at least one embodiment of the present disclosure and may be included in more than one embodiment of the present disclosure. However, such phrases do not necessarily refer to the same embodiment.

The systems and methods described above may be implemented as a method, apparatus or article of manufacture using programming and/or engineering techniques to produce software, firmware, hardware, or any combination thereof. The techniques described above may be implemented in one or more computer programs executing on a programmable computer including a processor, a storage medium readable by the processor (including, for example, volatile and non-volatile memory and/or storage elements), at least one input device, and at least one output device. Program code may be applied to input entered using the input device to perform the functions described and to generate output. The output may be provided to one or more output devices.

Each computer program within the scope of the claims below may be implemented in any programming language, such as assembly language, machine language, a high-level procedural programming language, or an object-oriented programming language. The programming language may, for example, be PHP, PROLOG, PERL, C, C++, C#, JAVA, or any compiled or interpreted programming language.

Each such computer program may be implemented in a computer program product tangibly embodied in a machine-readable storage device for execution by a computer processor. Method steps of the invention may be performed by a computer processor executing a program tangibly embodied on a computer-readable medium to perform functions of the invention by operating on input and generating output. Suitable processors include, by way of example, both general and special purpose microprocessors. Generally, the processor receives instructions and data from a read-only memory and/or a random access memory. Storage devices suitable for tangibly embodying computer program instructions include, for example, all forms of computer-readable devices, firmware, programmable logic, hardware (e.g., integrated circuit chip, electronic devices, a computer-readable non-volatile storage unit, non-volatile memory, such as semiconductor memory devices, including EPROM, EEPROM, and flash memory devices; magnetic disks such as internal hard disks and removable disks; magneto-optical disks; and nanostructured optical data stores. Any of the foregoing may be supplemented by, or incorporated in, specially-designed ASICs (application-specific integrated circuits) or FPGAs (Field-Programmable Gate Arrays). A computer can generally also receive programs and data from a storage medium such as an internal disk (not shown) or a removable disk. These elements will also be found in a conventional desktop or workstation computer as well as other computers suitable for executing computer programs implementing the methods described herein, which may be used in conjunction with any digital print engine or marking engine, display monitor, or other raster output device capable of producing color or gray scale pixels on paper, film, display screen, or other output medium. A computer may also receive programs and data from a second computer providing access to the programs via a network transmission line, wireless transmission media, signals propagating through space, radio waves, infrared signals, etc.

Having described certain embodiments of methods and systems for video surveillance, it will now become apparent to one of skill in the art that other embodiments incorporating the concepts of the disclosure may be used. Therefore, the disclosure should not be limited to certain embodiments, but rather should be limited only by the spirit and scope of the following claims.

1. A system comprising:
at least one mobile credential device having a location sensor;
a camera;
a physical access control system (PACS) server coupled to said camera;
a message server;
a security display station; and,
a communication network coupling all the above.

2. A method at a mobile credential device comprising:
receiving a user input of intention to enter an area of reserved access;
transmitting a credential;
transmitting an intention to enter the region of reserved access (RORA);
transmitting its location indicia; and,
receiving at least one of an acknowledgement and a rejection of authorization to enter.

3. The method of claim 2 further comprising:
performing an action and
requesting authorization to perform an action within the RORA.

4. A method at a mobile credential device comprising:
receiving a challenge or warning from the server when entering the penumbra;
transmitting a credential;
transmitting an intention to enter the region of reserved access (RORA); transmitting its location indicia; and,
receiving at least one of an acknowledgement and a rejection of authorization to enter.

5. At a mobile credential device, a method comprising:
sampling a plurality of location measurements;
transmitting a credential on the condition that at least two location measurements converge toward a region of restricted access.

6. The method of claim 2 further comprising:
transmitting a request to unfault an alert after entering the RORA without authorization.

7. The method of claim 2 further comprising:
requiring a user to perform an action; and
transmitting success to the server.

8. A method at a physical access control system (PACS) server, comprising:
receiving a credential and a location;
verifying the credential with a policy for time and place access;
transmitting an authorization to enter or perform an action within a RORA; and
issuing an alert only when incursion by an uncredentialed mobile device exceeds a threshold of time.

9. A method at a server, comprising:
receiving an image from a camera;
initiating a message, warning, or question to a user; and
transmitting an alert and credential information to a security output means when no authorization has been transmitted within a range of time.

10. The method of claim 9 further comprising:
unfaulting the alert upon receiving a credential and request to unfault the alert after entering the RORA.

11. A method at a server comprising:
sensing an entry into a penumbra; and,
transmitting a warning message and a request to present a credential.

12. The method of claim 11, further comprising:
transforming an image from a camera with credential indicia for transmission to a security display station.

13. A method at a security display station, comprising:
receiving images from a camera;
displaying an alert transmitted from a server;
displaying an unfault of an alert;
annotating an image from a camera with comments and an elapsed time clock; and,
transforming the image from the camera with credential indicia and elapsed time for augmented display.

14. The method of claim 8 further comprising:
setting a suppression condition on further alerts for a condition.

15. The method of claim 8 further comprising:
augmenting an image from a camera with credential information, alerts, unfaults, and
overriding a policy to transmit an authorization.

16. The method of claim 8 further comprising:
refusing submission of credential when the user is not within the vicinity of the protected area.

17. At a cloud security server, a method comprising:
notifying at least one mobile device of intrusion on the condition that an unauthorized presence is in its vicinity based on location service coordinates.

18. At a mobile credential device, a method comprising:
notifying the user to submit a credential, on the condition that at least two location measurements converge toward region of restricted access.

21. A physical access control system (PACS) which comprises a PACS server; coupled to at least one physical access control panel apparatus (panel); the panel coupled to at least one physical access portal actuator (actuator); and at least one wireless mobile gatekeeper device, all mutually communicatively coupled.

22. The system of claim 21 further comprising: a physical object deliverance system (pods) which comprises: a pods server, non-transitory media, and at least one mobile delivery agent apparatus wirelessly coupled to said pods server; said physical object deliverance system coupled by an application programming interface to said physical access control system; and wherein each device, apparatus, and server comprises at least one processor and non-transitory computer readable media tangibly encoded with data and computer executable instructions.

23. A system to control multiple levels of access in a multi-lock residential community comprising: a server communicatively coupled to at least one gatekeeper and to at least one portal, at least one delivery agent dispatcher, and to at least one delivery agent authentication device; at least one electronic lock for access to semi-private, semi-public, and common shared zones which actuate when a token presented by a delivery agent authentication device matches location, and date-time indicia; and a network coupling all the above subsystem elements.

24. A method for operation of a security augmented visitor entry system comprising: at a proprietor-controlled physical access control server, responsive to a gatekeeper apparatus, synthesizing a location-specific date-time valid access control token for portal actuator operation; transmitting said token to a mobile authentication device; receiving assurance, location, and date-time indicia from said mobile authentication device; and causing said portal actuator to enable access to the bearer of said mobile actuation device when assurance, location, and date-time indicia are acceptable to the gatekeeper.

25. The method of claim 24 wherein assurance indicia is at least one of text, audio, image, voice recognition, facial recognition, RFID, and a credential.

26. The method of claim 24 further comprising: synthesizing an anti-token which enables access when matching the location-specific date-time valid token; and distributing said anti-token to at least one location aware access control portal actuator.

27. The method of claim 24 further comprising: at a location-aware access control portal actuator, receiving an access control token from a mobile authentication device; determining the current location of the access control portal actuator; on the condition of determining a match of the location and date time range of the token and the current location and date time of the portal actuator, enabling access through the portal; and on the condition of failing said match, transmitting an alert to the server.

28. The method of claim 24 further comprising: at a mobile gatekeeper device, receiving, via the server, an authenticated mobile request to access at least one location specific portal during a date-time range; determining assurance by one of image, voice, text, credential, and RFID of the identity of bearer of said mobile authentication device; selecting a date-time range, persistence, and routing through location specific portals for access; and enabling generation and transmittal by the server of said token to the mobile authentication device.

29. The method of claim 28 further comprising: transmitting an invitation via the server to a mobile authentication device to access at least one location specific portal during a date-time range.

30. The method of claim 24 further comprising: at a mobile authentication device, transmitting a request to access at least one location specific portal during a date-time range with an authentication credential; receiving a token with date-time validity for at least one portal location; presenting said token when in proximity to each location specific portal; and discarding said token when expired.

31. The method of claim 30 further comprising: receiving an invitation to access a location specific portal.

32. The method of claim 24 further comprising: receiving from a fixed image capture and audio sensing device a verbal explanation and video of a visitor requesting access but not providing mobile device credentials; matching facial recognition indicia with a store of known residents or visitors; converting speech to text; transmitting text and images to a gatekeeper annotated in said store; receiving portal control instruction from said gatekeeper; and recording video, voice, and disposition of the request.
